(19) United States
(12) Patent Application Publication
(10) Pub. No.: US 2012/0251247 A1
(43) Pub. Date: Oct. 4, 2012

(54) MOBILE STAR WHEEL FEEDER

(75) Inventors: Herbert Ungerechts, Kerken (DE); Hans-Jörg Frank, Toenisvorst (DE); Dieter Scholten, Alsdorf (DE); Jürgen Janssen, Geldern (DE); Markus Hagedorn, Muelheim/Ruhr (DE)

(73) Assignee: Bayer MaterialScience AG, Leverkusen (DE)

(21) Appl. No.: 13/430,852

(22) Filed: Mar. 27, 2012

(30) Foreign Application Priority Data
Mar. 30, 2011 (EP) 11160511.9

(51) Int. Cl. B65G 53/66; B65G 41/00; B65G 53/30

(52) U.S. Cl. 406/34; 406/38; 406/41; 406/197

(57) ABSTRACT

A mobile star wheel feeder includes docking devices, flushing devices and control for the pneumatic conveyance of granules, in particular polymer granules, with preference polycarbonate granules. The mobile star wheel feeder, together with partially mobile sections of pipeline, can be set up at different locations underneath silos.

### BACKGROUND OF THE INVENTION

### Priority

Priority is claimed to European Patent Application No. 11 160 511.9, filed Mar. 30, 2011, the disclosure of which is incorporated by reference in its entirety.

### FIELD OF THE INVENTION

The field of the present invention is a mobile star wheel feeder with docking devices, flushing devices and control for the pneumatic conveyance of granules, in particular polymer granules, with preference polycarbonate granules. Such mobile star wheel feeder, together with partially mobile sections of pipeline, can be set up at different locations underneath silos.

### BACKGROUND

The granular product occurring in the reactor during the production of thermoplastics is plasticated in an extruder and formed into individual strands, which are cut into granules by means of a knife rotating in the granulating die. The granulation may be performed, for example, in a stream of liquid. Subsequently, the granules are dried and screened, in order to separate out agglomerates formed in spite of cooling. After that, the product is pneumatically conveyed to a mixing silo, from which the product is then filled and packaged. On account of the silo design and the filling strategy, mixing (homogenization) of the product inevitably takes place when it is removed from the mixing silo.

Depending on the further use when it undergoes filling, i.e. differentiated by type of packaging and the quantity in which they are packaged, the granules do not always pass directly into the packaging plants from the mixing silos, but may be conveyed into storage silos by means of the mobile star wheel feeder.

There is therefore the problem of providing a star wheel feeder with the aid of which granules can be pneumatically transferred into storage silos, the star wheel feeder not being stationarily located in one place, but able to be used mobility in a plant for different lengths of conveying distance and different types of granules.

A further problem is that of providing a mobile star wheel feeder which, after completion of the conveying process, is largely free from residual amounts of the granules previously conveyed therein and can be cleaned easily and reliably of any remains of granules possibly still present in the conveying line by flushing, for example with water and compressed air, so that contamination with following portions of granules can be ruled out with certainty.

### SUMMARY OF THE INVENTION

The problem addressed here has been solved by providing a device comprising a star wheel with an integrated working platform, a mobile docking tube, possibly a fully automatic control and with a stationary part of the plant substantially comprising conveying pipelines, conveying diverters and associated structural steel beams, which includes a base frame with an integrated working platform provided with a traveling mechanism, in order to accommodate all the components for a working pneumatic conveyance (dense flow conveyance), in order thereby to set up a conveyance efficiently at different silo locations.

### BRIEF DESCRIPTION OF THE DRAWINGS

In the drawings, wherein like reference numerals refer to similar components:

FIG. 1 is a mobile star wheel in side view and shows a state of readiness for conveying operation;

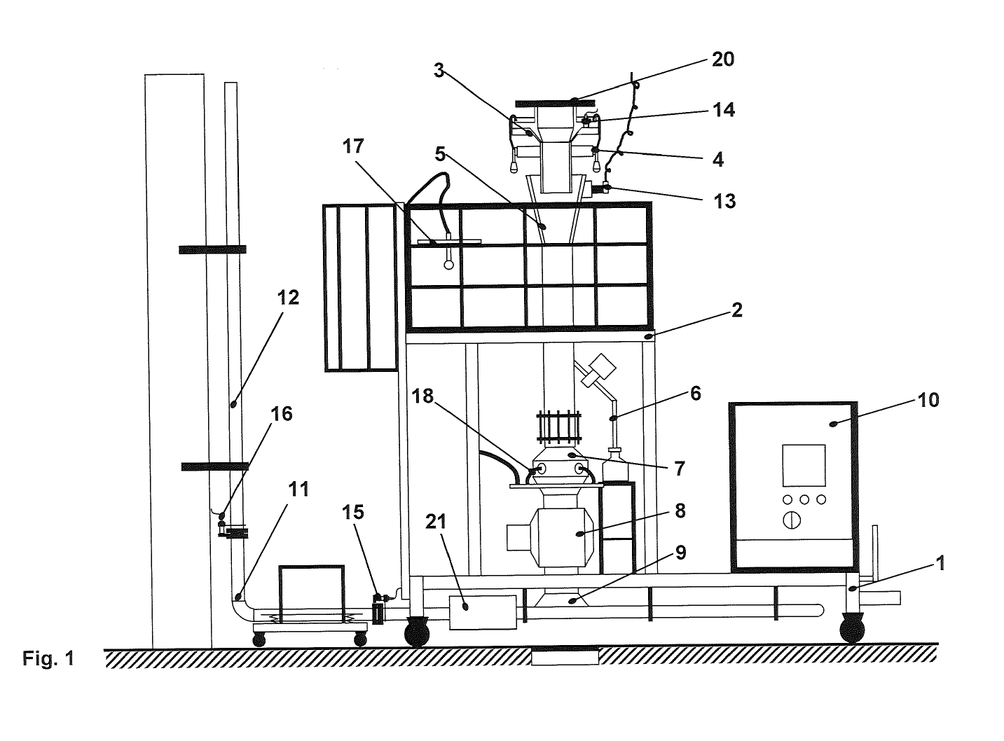

FIG. 2 is a mobile star wheel in side view and shows a state of readiness for the flushing process; and

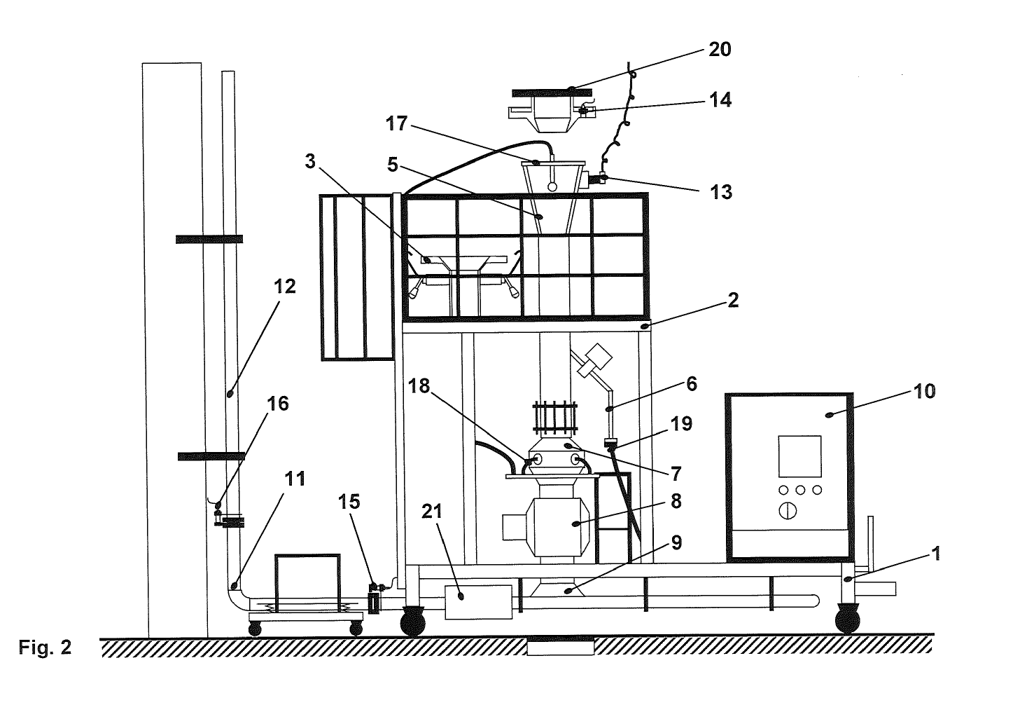

FIG. 3 shows the use of a small tractor (mover) on the mobile star wheel feeder.

### DETAILED DESCRIPTION OF THE PREFERRED EMBODIMENTS

As used herein, contamination refers to a very wide range of foreign powdered materials, such as comminuted granules and the granules left behind after a change of product. The introduction of such foreign materials into polymers, in particular into high-value polycarbonates, can have a devastating influence on the end product, which are to be distinguished, for example, by conforming to very narrowly defined specifications with regard to optical or mechanical properties.

The problem addressed here has been solved by providing a device comprising a star wheel with an integrated working platform, a mobile docking tube, possibly a fully automatic control and with a stationary part of the plant substantially comprising conveying pipelines, conveying diverters and associated structural steel beams, which is characterized by the following features:

a base frame (1) with an integrated working platform (2) is provided with a travelling mechanism, in order to accommodate all the components for a working pneumatic conveyance (dense flow conveyance), in order thereby to set up a conveyance efficiently at different silo locations. The travelling frame accommodates at least the following pneumatic conveying components:
a conical docking flange (3), free from any dead space, with quick-clamping devices (4) and an associated inlet funnel (5) to the star wheel;
a sampling point (6) with table;
a leakage-air collecting container (7) with a star wheel (8) and a feeding shoe (9);
an air-rate control station with a bypass;
the pipelines for compressed air, fully demineralized water, granules, granules-air mixture and waste water;
the closing and controlling valves and the conveying diverter (21); and
possibly the local control unit (10) for the air-rate control station and for the conveying and flushing processes.

The working platform (2) with the climbing ladder serves for docking onto the silo outlet (20), plugging in the coded connector (13) and also for setting up the flushing process.

All the valves and pneumatic conveying components that are used can be obtained as standard on the market.

A mobile conveying pipe (11) forms the connecting pipe between the conveyor outlet of the mobile star wheel and the part of the plant (12) with permanent pipework, which forms the conveying line to the silos. The mobile conveying pipe is preferably carried in a spring-mounted manner on a travelling frame. Springing-in of the pipe at the fitting interfaces allows the male and female flanges that are free from dead space to be fitted more easily.

The different locations of the mobile star wheel and the different target silos result in conveying lines of various lengths and, together with the numerous types of granules, give rise to a large number of conveying parameters. Automatic setting of the conveying parameters is therefore helpful for the operator.

Therefore, in a preferred embodiment, an automatic location identification on the basis of a coded E-type connector (13) is used for each silo, fitted from the silo outlet to the star wheel inlet when docking the feeder. With the connector coding, the silo is identified and, together with a table of parameters stored in the program, the control determines the conveying parameters when the type of granules and the target silo are manually preselected. Furthermore, by this silo location identification and after manual preselection of the target silo, the setup and verification of the conveying paths are automated. For this purpose, the initiator (14) at the silo outlet and the initiators (15, 16) at the two pipeline flanges to be fitted for operation are also assigned.

The data transfer between the local control and the higher-level central control takes place with preference via a wireless network (WLAN). This additionally offers the advantage of significantly reduced cabling for the numerous locations of the mobile star wheel feeder. By analogy, the WLAN is also used for further mobile devices.

With particular preference, all the component parts that come into contact with product are structurally designed to be free from dead space. As a result, cross-contamination is avoided.

In a preferred embodiment, various flushing components are used, such as flanges with spray balls and nozzles, water inlets controlled by solenoid valves and waste-water pipework, and form the basis for automatic cleaning of the mobile star wheel. In preparation for the flushing process, just a few manual modifications are carried out. These include, for example, mounting a flange with a spray ball (17) onto the inlet funnel and onto the filter stub. Furthermore, for example, a waste-water tube (19) is screwed onto the stub of the sampler (6). All further components that come into contact with product, and should consequently be flushed, are preferably fixedly connected directly to flushing devices (water inlets partly in the form of nozzles (18)). The spray ball preferably has a large number of water nozzles, so that parts of the plant can be flushed with water within a range of almost 360° . In the region of the leakage-air collecting container (7), axial solid-cone nozzles (18) that spread the water jet by 120° are preferably used.

In a particularly preferred embodiment, the cleaning of the plant is carried out in a fully automated manner by a control. For this, preferably various flushing phases are activated with different flushing times one after the other, if need be at least some more than once. Two main flushing phases can be distinguished here, that is the flushing of the mobile star wheel (a) and the flushing of the conveying line (b), beginning from the conveying diverter (21), via the mobile conveying pipe (11) and the part of the plant (12) with fixed pipework up to the inlet diverter of the target silo. In one particular embodiment, the flushing takes place, by way of example, as follows:
a. In the course of the star wheel cleaning, the section of pipeline above the star wheel is flooded with fully demineralized water and backed up until water flows away over the sampler. The backed-up water is subsequently discharged over the operation of the star wheel in the direction of the conveying line, preferably with compressed air, into a waste-water system. Alternatively, the flushing water may also flow away without pressure into a nearby waste-water system. This flushing process is preferably repeated a number of times. After that, fully demineralized water is introduced together with the rotating star wheel and discharged as waste water. The section of pipeline above the star wheel together with the star wheel (8), with the feeding shoe (9) and with the leakage-air collecting container (7), is dried by feeding in compressed air via the flushing components and through the operation of the star wheel. The cleaning process of the mobile star wheel can in this case be carried out independently of the remaining part of the plant (lines with fixed pipework, 12; silos).
b. The cleaning of the complete length of conveying line from the conveying diverter (21) of the mobile star wheel to the inlet diverter of the target silo is preferably controlled by a separate flushing program. For this purpose, a bypass is connected via the conveying diverter (21) to the conveying line. Via the bypass, the conveying line is cleaned, preferably with a mixture of compressed air and fully demineralized water, and the waste water is introduced into a separate waste-water pipeline system. Following that, only compressed air is introduced via the bypass into the length of conveying line for drying. The time during which the compressed air is introduced may be interrupted a number of times, in order that residual amounts of water from gradients can collect once again and can subsequently be blown away more easily. The bypass offers the advantage that the star wheel does not have to be flushed for cleaning the conveying line. In the case of conveying operations with identical products, the star wheel can be used again quickly. The company operating the plant saves time and costs of energy and resources.

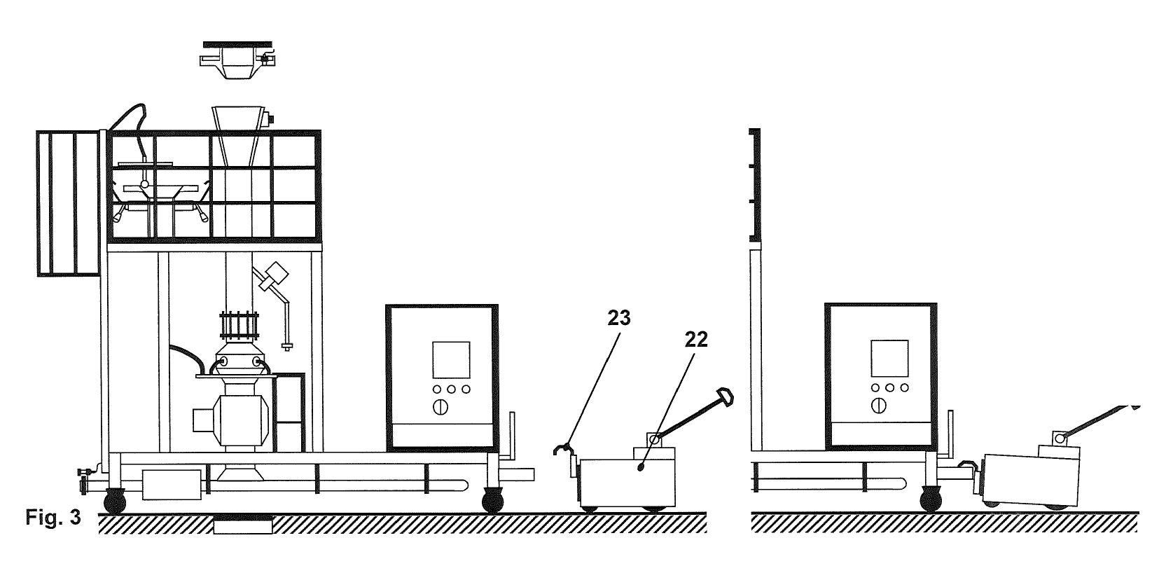

Electrical drives, possibly locationally movable drives, are preferably used as an aid for moving the mobile star wheel feeder around. Locationally movable drives, i.e. drives which can be moved around independently and can be uncoupled from the material transported, have the advantage that they can be used for different transporting tasks. This so-called small tractor or mover (22) can be connected by a lifting mechanism, including two adaptation arms (23), with interlocking and frictional engagement onto the frame of the star wheel feeder. This allows the operator to accelerate, brake and steer the star wheel feeder by way of a driven steerable third wheel of the mover, as represented in FIG. 3.

Thus, a mobile star wheel feeder is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A device comprising a base frame (1) with an integrated working platform (2), is provided with a traveling mechanism, the traveling frame accommodating at least the following pneumatic conveying components:
a. a conical docking flange (3), free from any dead space, with quick-clamping devices (4) and an associated inlet funnel (5) to a star wheel;
b. a sampling point (6) with table;
c. a leakage-air collecting container (7) with the star wheel (8) and a feeding shoe (9);
d. an air-rate control station with a bypass;
e. pipelines for compressed air, fully demineralized water, granules, granules-air mixture and waste water; and
f. closing and controlling valves and a conveying diverter (21).

2. The device according to claim 1, wherein all component parts that come into contact with product are structurally designed to be free from dead space.

3. The device according to claim 1, wherein a working platform (2) with a climbing ladder includes a device for docking onto a silo outlet (20), a device for plugging in a coded connector (13) and also a device for setting up a flushing process.

4. The device according to claim 1, wherein a local control unit (10) controls the air-rate control station and, together with a higher-level central control, conveying and flushing processes.

5. The device according to claim 4, wherein a data transfer between the local control unit and the higher-level central control takes place via a wireless network (WLAN).

6. The device according to claim 1, wherein an automatic location identification on the basis of a coded E-type connector (13) is performed for each silo, fitted from a silo outlet to a star wheel inlet when docking a feeder.

7. The device according to claim 1, further comprising a lifting mechanism, including two adaptation arms (23), with interlocking and frictional engagement onto the frame of the device, the lifting mechanism being adapted to allow connection of a small tractor or mover (22) to the device.

8. The device according to claim 1, wherein at least one of the components that come into contact with product are fixedly connected directly to flushing devices.

9. The device according to claim 8, wherein the flushing devices comprise spray balls and/or axial solid-cone nozzles, which have a multiplicity of water nozzles.

10. A method for conveying granules, comprising conveying granules using the device according to claim 1.

11. A method for cleaning a device according to claim 1, wherein flanges with spray balls (17) are mounted onto the inlet funnel and onto a filter stub; a waste-water tube (19) is screwed onto a stub of the sampler (6).

12. A method for cleaning a device according to claim 1, wherein a section of pipeline above the star wheel is flooded a number of times with fully demineralized water and backed up and the water flows away over the operation of the star wheel or is discharged over the operation of the star wheel with compressed air into a separate waste-water system.

13. A method for cleaning a device according to claim 1, wherein fully demineralized water is introduced together with the rotating star wheel and discharged as waste water.

14. A method for cleaning a device according to claim 1, wherein a section of pipeline above the star wheel together with the star wheel (8), with a feeding shoe (9) and with the leakage-air collecting container (7), is dried by feeding in compressed air via flushing components and through the operation of the star wheel.

15. A method for cleaning a device according to claim 1, wherein a complete length of conveying line from a star wheel diverter (21) to an inlet diverter of a target silo is cleaned by a mixture of compressed air and fully demineralized water via a bypass, and waste water is introduced into a separate waste-water pipeline system.

16. A method for cleaning a device according to claim 1, wherein drying of a complete length of conveying line from a star wheel diverter (21) to an inlet diverter of a target silo is performed by introducing compressed air via a bypass.

17. A method for cleaning a device according to claim 1, wherein an operation of drying a complete length of conveying line from a star wheel diverter (21) to an inlet diverter of a target silo is interrupted a number of times.
